(19) United States
(12) Patent Application Publication
(10) Pub. No.: US 2022/0400105 A1
(43) Pub. Date: Dec. 15, 2022

(54) METHOD AND SYSTEM FOR GENERATING ENCRYPTION KEYS FOR TRANSACTION OR CONNECTION DATA

(71) Applicant: THALES DIS FRANCE SAS, MEUDON (FR)

(72) Inventors: Maxime NOUAILLE, LA CIOTAT (FR); Thierry KARLISCH, LA CIOTAT (FR)

(73) Assignee: THALES DIS FRANCE SAS, MEUDON (FR)

(21) Appl. No.: 17/619,754

(22) PCT Filed: Jun. 18, 2020
(86) PCT No.: PCT/EP2020/067021

§ 371 Date: Dec. 16, 2021

(30) Foreign Application Priority Data
Jun. 25, 2019 (EP) 19305842.7

(51) Int. Cl. H04L 9/40

(52) U.S. Cl. CPC H04L 63/083; H04L 63/0435; H04L 63/065

(57) ABSTRACT

Per CFR 1.121, Applicant hereby amends the abstract of the application by substitute abstract, by submitting:
(i) instruction for the cancellation of the previous version of the abstract; and
(ii) a substitute abstract in compliance with 37 CFR § 1.121(b)(2)(ii).
RE i)

Please cancel the previous version of the abstract.
RE ii)

A clean version of the substitute Abstract is set forth on the following page.
No new matter has been added.

### FIELD OF THE INVENTION

The invention relates to a method and system for generating encryption keys for sensitive transaction data.

In particular, the encryption keys are intended to secure sensitive transaction data which may preferably be presented as secure 2D codes but not exclusively.

It concerns an application or use of the method and system for generating encryption keys for an exchange of sensitive data, in particular between a service server and a mobile terminal application or between terminals.

The invention finds an application or use in particular in securing exchanges of sensitive data between servers of a bank (or financial institution) and applications of mobile communication terminals (running operating systems such as Android, IOS, etc.) via QR codes (quick response codes, 2D codes, bar codes). These exchanges can enable digital banking transactions (eBanking) including retail and wholesale payments.

The invention can be used to generate encryption keys making it possible to secure any method or technique, in particular by USB, Bluetooth, NFC or other communication technique, for logging in to servers, information access portals, computers or any remote communication device, etc.

### PRIOR ART

A QR code (or 2D code) is commonly used for various digital banking transactions (eBanking) such as registration (or enrollment), logging in to or accessing a website, making transfers, managing beneficiaries, opening an account, applying for cards, or any other operations requiring validation by a user.

In particular, the invention is aimed at transactions that are enabled and controlled in particular using the “EZIO mobile” device from Gemalto SA.

Using a mobile application provided by their bank, a user can validate and complete a transaction by scanning or capturing a unique QR code generated for that purpose. This method is supposed to facilitate the user experience.

This QR code often includes sensitive transaction data (for example, authentication settings for a login or private account numbers and a currency amount for a money transfer operation, etc.); This sensitive data could be used by attackers or fraudsters for all kinds of online attacks. This is why, in order to guarantee a certain level of security, QR codes are usually encrypted by standard cryptographic algorithms (3DES, AES, etc.).

This security feature involves two things:
The encryption key must be securely shared with the client (mobile application) in order to perform decryption.
As banks' mobile applications are generally intended to be published on online stores (Apple, Google, etc.) so that anyone can download them, the key must be diversified to keep from compromising all users if it has been hacked.

The inventors found that the simplest solution would have been to put the key directly into the mobile software application and apply an obfuscation method to protect it, but as the application would be easily accessible on the Internet and it would be possible to retrieve the key quite easily by “reverse engineering” which is unacceptable in terms of risk for the banks.

Furthermore, in this solution, the key is unique and not diversified by user because it is directly contained in the software application code.

They also thought that the key could be shared via secure TLS-type communication during the lifetime of the software applications, but the level of security would have been insufficient, the user experience would have been disrupted by long waiting times; Furthermore, it is necessary to make online transactions to exchange the key with the bank.

Furthermore, authentication servers are known to include HSM (hardware security module) modules whose standard function is to perform OTP-type cryptographic calculations for authentication or validation purposes in order to make electronic connections. The invention can be applied to structures and functions of HSMs and/or authentication servers known to the person skilled in the art, with commands that are standardized or recommended to varying extents. Their structure or functions can be in line with those of Thales HSMs or authentication servers such as “SafeNet Luna Network HSM” or “Thales Payshield 9000”.

These HSMs generally operate as follows: Secret keys related to the generation/verification of OTPs are securely exchanged with end-user terminals and then stored in the authentication server's database (HSM), usually encrypted with another secret generated by and known only to the HSM. When verifying, for example, an OTP, the authentication server requests the HSM to decrypt the corresponding key to perform the reverse computation for verifying the OTP and then returns the result to allow or deny a login.

WO 2019/026038 A1 relates to a method for authenticating a transaction. The method implements a request for authentication of a transaction including the details of the transaction. A unique key shared between a service provider and a mobile phone is set up in advance. The transaction details are encrypted with the unique key and returned to the user in the form of a 3D code. The user decrypts the transaction data to confirm the transaction and a OTP is calculated based on the transaction data. This OTP is entered and returned by the user to have the transaction validated by the service provider.

### Technical Problem

More and more banks are relying on One-Time-Password (OTP) mechanisms to secure their digital (or electronic) banking transactions (eBanking). OTP values are calculated by the mobile software application using a shared secret key and verified by the bank (on a back-end) through an authentication server.

This shared secret key is often securely exchanged during the user enrollment process and stored in a protected memory area dedicated to the software application. In this configuration, the shared secret key is only known to the mobile application, and the authentication server hosted in the bank (on a back-end). Each shared secret key of an enrolled user is different from the keys of other users.

The inventors had the thought that this secret key sharing could be used directly to encrypt the QR code data, but since this is not the primary purpose of an authentication server, nor is it a standard feature, it would entail significant additional modifications and costs on both the mobile terminal and server sides to address the problem solved by the invention.

Given the context described above, the inventors propose to implement a more suitable solution preferably using already-available resources to facilitate the deployment of the solution.

### Objective of the Invention

One of the objectives of the invention is to solve the above-mentioned drawbacks.

The invention provides a transaction method or system that is protected or secured by the implementation of dynamic encrypted keys to encrypt and decrypt transaction data and that can be implemented or deployed very easily or very economically with a very good level of security.

A further objective of the invention is to provide a means for generating a dynamic transaction data encryption key for use in the above transaction method and system.

Another specific and preferred objective of the invention is a banking transaction method implementing a step of validation or control of the transaction data by the user via the use of encrypted QR codes with dynamic key containing all or part of these transaction data;

Another objective of the invention is to allow transactions, in particular for logins to services or hardware or software entities by different communication protocols such as USB, Bluetooth, etc.

The purpose of the invention is to generalize the use of (authentication) servers to secure any data exchange.

### SUMMARY OF THE INVENTION

The invention according to a preferred embodiment comprises hijacking or using at least in part an initial or predefined function of an authentication server to secure electronic transactions in a broad sense. In particular, the invention makes it possible to use a “Get Dpuk” command or equivalent specific to the authentication server to obtain (on request) an OTP element or dynamic key element and use it to encrypt exchanges.

In particular, the invention appropriately arranges or configures a sensitive data transaction system or method (preferably implementing transaction steps, in particular banking or payment), by reusing or diverting commands that are standard or commonly used in an authentication server.

The invention may provide for a library of commands or at least one command (or set of commands) specific to authentication servers such as “get DPUK”, “generate” or “embed” a “challenge” in a command for generating a dynamic “DPUK” key intended for the authentication server or an HSM similar to that of an authentication server; These commands make it possible to interact with this authentication server and to obtain a standardized and/or certified dynamic key, in order to use or combine it in the above-mentioned sensitive data transaction system or method.

The system may be configured to allow communication interaction and/or ad hoc interfaces and access to this authentication server. In particular, the invention can establish a secure connection or secure communication interface between a computer or Internet server of any entity (in particular a bank) via any communication and/or data and/or software storage network, in particular via the “cloud” (that is cloud computing).

The invention enables decentralized access to dynamic key generation resources via a cloud. Thus, the deployment of the invention can be facilitated through a cloud (private or public) to allow easy and quick collection of encryption/decryption (or verification) keys.

The invention also provides in parallel for loading a software application arranged or configured to use the similar or identical “GEt DPUK” function or command and obtain the same dynamic key (as generated by the authentication server) into a mobile terminal (or into a security or trust device) adapted to perform transaction validation assistance or to secure a transaction.

For this purpose, both the authentication server (preferably with an HSM security module) and the device or terminal assisting in the execution of a transaction can contain or share the same “Kshared” key or shared value.

Thus, the invention may provide that the targeted transaction system be adapted or configured to allow a generation and use of a dynamic encrypted key to encrypt and decrypt sensitive transaction data for different purposes, such as control or validation of transactions, or logging in to a system, or access to an online or remote service, in particular from a bank or financial organizations or other entities.

To this end, the invention has as its object a (communication) system comprising a computer or communication server (in particular an authentication server) comprising secret keys, each associated with an identifier (ID1) of a person, a computer entity, or a terminal;

The server is characterized in that it is configured to generate and communicate, on demand with the identifier, and remotely, a dynamic key from a secret key, and a variable and/or a challenge, said dynamic key serving as a dynamic encryption/decryption key or base key for obtaining a dynamic data encryption/decryption key.

The dynamic nature of the key can result from the use of a variable and/or a challenge that can be valid for a certain predetermined time or linked to an event.

According to other features:
Said variable (or said challenge) may be known to the terminal or computing entity making the request. Said variable (or challenge) can be known either because it was generated in an identical way locally, or because it was received (or exchanged) in particular from the authentication server.
The server may be an authentication server (according to the preferred mode to facilitate the deployment of the invention).

The invention finds application in a system for data communication between at least one terminal and a computing entity, said system comprising an authentication server as above (according to claim 4), a service computing entity, and client communication terminals;

The system can preferably be configured to:
authenticating each terminal or user with the authentication server based on a key shared between each terminal and said authentication server; the system may be characterized in that said system is configured to:
   request the authentication server or the terminal to generate a dynamic encryption key from said terminal shared key, and from a challenge and/or a variable,
   and use said dynamic key to encrypt or decrypt said data exchanged between said terminal and said computing entity.

According to other features of the system:
Each terminal may be configured with a memory having a shared encryption/decryption key separate from that of another terminal and shared with said authentication server.
Said dynamic key may comprise or be an OTP, HOTP or TOTP.

The invention further relates to a method of communicating data between at least one terminal and a computing entity, said method implementing a system comprising said authentication server (according to claim 4), a service computing entity, and terminals; The method may comprise steps for:
configuring said system to authenticate each terminal or user with the authentication server based on a key shared (Kshared) between each terminal and said authentication server;
requesting the authentication server or the terminal, to generate a dynamic encryption key from said shared key corresponding to the terminal, and from a challenge and/or variable,
using said dynamic key to encrypt or decrypt an exchange of data between said terminal and said computing entity.

According to other features of the method:
Said exchange of data between said terminal and said computing entity is distinct from an exchange of authentication data comprising a one-time use number exchanged between said terminal and said authentication server or said communication entity;
Said dynamic encryption key may be generated by said authentication server, in response to a specific (standard or certified) command issued by said communication computing entity.

### The Invention has the Following Advantages

As the dynamic key or a similar secret is still needed, this solution could be easily implemented with any authentication server on the market and with any mobile terminal (smartphone, tablet, PDA, etc.), having a software development kit (SDK) with standard OTP generation functions, both hardware or software resources that banks or other entities (user corporations, or public or private organizations) already have.

The invention may require minimal software development on mobile terminals (or electronic trust or security devices such as EZIO EYE from Gemalto SA) and in the back-end computers or servers of the bank or other private or public entities.

The key used to decrypt the QR code (2D code) may not be stored anywhere in the mobile application; instead it is changed (dynamically) with each transaction to enhance security.

The bank does not need to incur additional hardware and/or software infrastructure costs to implement a complicated process for storing and managing these dynamic keys;

The decryption (verification) process can be offline; It can be performed even if the mobile software application is not connected to the network, which is a very important advantage for the user.

The invention can be extended to any hardware OTP generation device separate or distinct from an authentication server.

### BRIEF DESCRIPTION OF THE FIGURES

FIG. 1 shows a first part of the method and system for securing an electronic transaction between a transaction server and a client terminal;

FIG. 2 shows a second part of the method and system for securing an electronic transaction between a transaction server and a client terminal;

FIG. 3 shows a method of using a dynamic server key (authentication or DPUK, OTP keys) for encryption/decryption between a transaction server and a client terminal or between terminals;

### DESCRIPTION

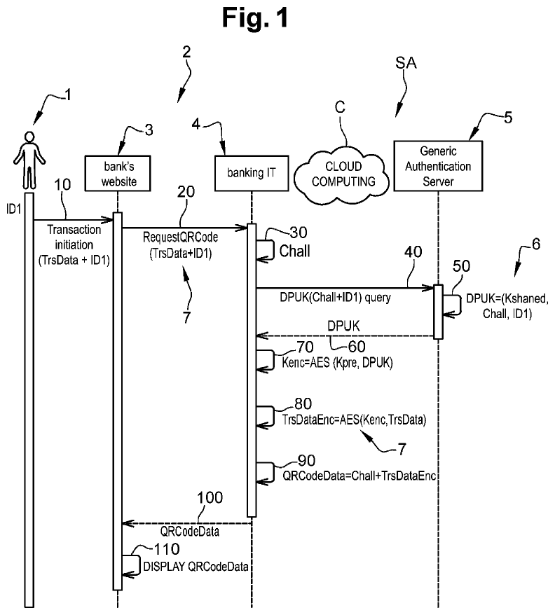

FIG. 1 shows a first part of a method (and system 2) for a data communication method between at least one terminal and a computing entity. This method is intended to secure an exchange 10 of sensitive data (sensitive electronic transaction and/or login data) between a transaction server 3 and a client terminal 1.

A transaction is an exchange of data between two software or hardware entities. It can be used for different purposes, in particular for logging in to a service or for logical or physical access, or for financial transactions, payment, enrollment, registration, financial transfers, exchanging sensitive data, etc.

The method may implement or advantageously use an already-existing system comprising an authentication server, a service computing entity (transaction server 3) and client terminals 1; This system may already be configured to authenticate each terminal or user with the authentication server on the basis of a key shared between each terminal and said authentication server.

Thus, deployment of the invention is facilitated if the system already provides such functions and hardware.

The transaction 10 comprises a step of encrypting the sensitive data with an encryption key,

According to one feature of the preferred embodiment of the invention, the method comprises the steps of configuring at least one client terminal and authentication server to generate a dynamic authentication key based on a shared key, a challenge, and (optionally) an identifier corresponding to each terminal;

The server requires an identifier from the terminal or user or an application to retrieve the same key or shared secret from a database in order to retrieve the same dynamic key.

The sending terminal does not necessarily need its own identifier or one relating to an application it hosts or to the user in order to generate the same key. In contrast, the terminal communicates an identifier to the key server to retrieve the same shared secret.

Thus, the method may implement steps to request the authentication server for a dynamic encryption key generation based on the above elements.

As for the terminal, the method may require the same thing, but the terminal may be without an identifier, because the terminal might have only one shared key whereas the server may have many shared keys corresponding to each terminal or user of the system.

The server can retrieve the corresponding shared key based on a user and/or terminal identifier (for example, mobile phone IMEI)

In the example, the authentication server 5 may be linked to or comprise a hardware security module (HSM) that stores, in a secure memory, encryption keys (kshared) that can be associated with users or user terminals (or communicating computing entities or remote computers) and shared with client applications 1 for authentication purposes; An authentication server generally comprises any hardware and software means necessary for the security of the information it contains.

However, the authentication server 5 may be any equivalent remote computer with strong secure communication and storage capabilities, as well as high-level encryption keys dedicated to authentication. The storage can be done in particular in security elements (SE), associated USB keys, or other hardware media connected or soldered on a server printed circuit as long as the security level is guaranteed.

The authentication server can preferably include network communication interfaces (internet, intranet) to be accessible in the cloud via any telecommunication network, Wifi, Bluetooth, NFC, mobile telecommunication. Preferably, mutual authentication or secure communication procedures can be implemented such as HTTPS.

The authentication server can be dedicated to the transactions to be performed by the method or system. However, advantageously, it is not dedicated but part of a separate pre-established authentication system.

In particular, the authentication system may be designed for purposes entirely other (distinct) than those for which it is used in the invention. Rather, it is used exclusively to authorize connections following authentication of a user wishing to access an online service or operation via a user communication device transmitting a code, preferentially of an OTP (one-time numerical password). It may not be intended or dedicated to any transaction service.

The authentication server may therefore be separate from or unrelated to a banking, electronic financial transaction or e-Commerce service, which is preferentially covered by the field of application of the invention.

According to a characteristic, the transaction 10 is distinct from an authentication operation, in particular using a one-time numerical password (OTP). Such an OTP allows a comparison with an OTP issued or generated in parallel in the authentication server for authentication.

The authentication system can exclusively make it possible to provide a network service for validating information such as a user's name and password, for granting a login, for verifying certificates to authenticate people, for verifying one-time passwords (OTP) generated remotely by a user's device, or for sending an OTP to a user which that user must return to the authentication server via a channel parallel to that by which it was received in order to allow a login to a remote server, or any other access.

Furthermore, in the example, the client software applications 1 may comprise mobile applications hosted on mobile terminals, or client applications of personal computers, tablets, personal digital assistants, etc.

According to one feature of the preferred embodiment, the method provides for requesting a dynamic authentication key from the authentication server 5 and/or the user terminal 1;

Indeed, both the server and the terminal are able to initiate an encryption of sensitive data and to communicate to the other the encrypted result with, in particular, a challenge for dynamic encryption and an identifier to find the shared key.

According to another feature of the preferred embodiment, the method provides for the use of the dynamic key DPUK for encrypting or decrypting sensitive data exchanged between said terminal and said computing entity.

Indeed, this dynamic key will not be used here to authenticate oneself as with an OTP, but to encrypt all the sensitive data to be exchanged.

The authentication server 5 comprises memories (or a secure storage database) for storing encryption keys 6, DPUK or kshared. These keys 6, DPUK, kshared are shared with/common to dedicated client software applications 16 for authentication purposes in client terminals of a user; According to another feature of the preferred embodiment, the transaction system 2 of the invention is also configured to encrypt said sensitive data 7 with said dynamic encryption key (Dpuk).

In fact, according to the invention, the authentication server does not perform this encryption operation. It merely provides the “Dpuk” key, in a manner known per se by means of a normal command provided per se in the state of the art exclusively for purposes distinct from an electronic transaction).

However, this “Dpuk” key is used, thanks to the invention, for electronic transaction purposes (particularly banking) by a server 4, 3 of the transaction system 2.

In this case, the transaction server may be single, multiple or, in this case, double, since it comprises the server 3 (or an online site on the Internet) of a service provider, for example a bank or financial institution. That website or those computers are associated or linked by any means of communication to a back-end server 4 (or mainframes) of a service provider, for example here, a financial service provider of a bank or financial institution.

In operation, the authentication server 5 of an authentication system SA receives a dynamic key command 140 from a transaction server 4 of a transaction system 2; And in response, the authentication server 5 proceeds to generate a dynamic encryption key (Dpuk);

The authentication system includes an authentication server/client and uses shared or diversified encryption keys with dedicated client applications for authentication purposes; The transaction system 2 is of the server/client type and uses the same encryption keys 6, DPUK, “Kshared” shared with (or diversified among) dedicated client application keys for transaction purposes,

According to one feature of the preferred embodiment, the dynamic encryption key (DPUK) is generated by the authentication server 5 in response to a specific command or request 40 of a standard or certified type, issued by the transaction server 3 or a server or computer 4 associated with or linked to the transaction server 3 or website of a service provider.

With reference to FIG. 1, the different interactions or steps of an example of a method and system for securing an electronic transaction between a transaction server and a client terminal are described below.
In step 10 a user 1 connects to a banking site 3 of their bank via a desktop or laptop computer or even a tablet (not shown), and they initiate a fund transfer transaction such as a transfer from their account to an external third party account; They fill out an online transfer form with transaction data (TrsData), and a user identifier ID1 and proceeds with the transaction by clicking on a button;
In step 20, the bank site 3 sends a QR code or 2D code request to the bank's computers 4 (back office, back-end) to secure and confirm all the data (TrsData) of the transaction (amount, debit account, credit account, beneficiary, date of the transfer, etc.), that transaction data are associated with the user identifier or an identifier linked to a user's device or terminal or to a user account or a mobile terminal software application; The identifier is linked to the shared key (Kshared) between the terminal and the server 5;
In steps 30 and 40, the bank computers 4 generate a challenge (Chall) and then send a dynamic key request DPUK carrying the challenge (chall) and the identifier ID1, For this purpose, a preferably secure connection is established with an authentication server 5. Preferably, the connection is made through the cloud (C).

The challenge (and/or variable) is transmitted with an identifier ID1 (for example, an identifier of the terminal such as IMEI or of an application hosted by the terminal, or an identifier of the user) and/or another identifier related to the shared key (Kshared) of the user terminal. Alternatively, this identifier ID1 may be part of the challenge, which could comprise the identifier itself as a fixed part and a variable part complementing the identifier to form the challenge as a whole (for example, a fixed radical forms the identifier and a variable challenge completes the identifier as a suffix).

The authentication server 5 may be independent of the bank's transaction system but may remain accessible, on request, according to a preferably well-defined or secure procedure, to any external communication system, particularly a client-server type system. An HTTPS connection can be set up or another connection via VPN for example.

For this purpose, the bank's computers or server 4 can be configured (including the IP address of the authentication server, or other connection procedure) to establish a connection 40 and exchanges 60 with the server 5 according to a predefined connection procedure in response to the request 20 from the banking site 3.
In step 50, in response to the DPUK request 40, the authentication server identifies the shared key corresponding to the user's terminal based on an identifier accompanying the challenge, generates a dynamic key DPUK with a shared key (Kshared) based on the challenge as a parameter; The DPUK element may be calculated based on a standard OTP (HOTP in the invention—based on counter incrementing) returned by the authentication server. Other versions of OTPs can be considered such as: TOTP or challenge/response known to the person skilled in the art.

The authentication server can be configured to allow a connection with a list of servers or computers previously identified and authorized to request a dynamic key according to a pre-established process. The server therefore contains a list of server or computer identifiers and connection data (such as MAC addresses, IP addresses, domain names, associated passwords).

A mutual authentication procedure between the entities 5 and (3 or 4) may be followed to allow access to the authentication server 5, (for example: JWT (Json web token) or in the invention a JSESSIONID).
In step 60, the dynamic key 6 (or element) DPUK is transmitted back by the server 5 to the requesting entity 4, in this case the bank, via the secure communication channel, in this case the cloud (C);
In step 70, the entity 4 has received DPUK and in response calculates an encryption key (Kenc) based on DPUK and a formatting key (Kpre); This key (Kpre) makes it possible to change the data format or the number of bits (from 8 to 16 bits for example) and is known by both the server entity and the user's terminal (that is mobile application). This key does not necessarily have to be secure. The formatting step with the formatting key is not essential to the principle of the invention.

Here we perform an encryption calculation with a symmetric encryption algorithm such as AES, but other algorithms can of course be considered (DES, 3DES, etc.)
In step 80 of the method or program in the hardware and software entity 4, an AES (or, as before, DES or 3DES) encryption of the transaction data (TrsData) using the key (Kenc) obtained previously is provided for subsequently to obtain an encryption of the transaction data (TrsDataEnc) with a dynamic key;
In step 90, the above dynamically obtained encrypted transaction data (TrsDataEnc) may preferably (but not necessarily) be transformed into a 2D code (or QR code) format by also including the challenge (chall) in the transformation to obtain QRCodeData=Chall+TrsDataEnc; Alternatively, the values or data (TrsDataEnc) and the challenge can be transmitted in any other format known to the skilled person, in particular digital, binary, alphanumeric, analog signal, image.
In step 100, the bank entity 4 can finally return information comprising the dynamically encrypted transaction data, optionally in the form of a QR code or 2D code (QRCode Data). This information is the response to the initial request 20 from the bank's website 3 (or other service provider or computer system or computer requiring a dynamic DPUK element as secure as an OTP) and is intended to make the user's 1 transaction request 10 secure.
In step 110, the bank's website 3 displays, on a web page, the transaction information including the transaction data, in particular for verification or control by the user (QRCode Data); This information may be presented in the form of a QR code (or other possible form).

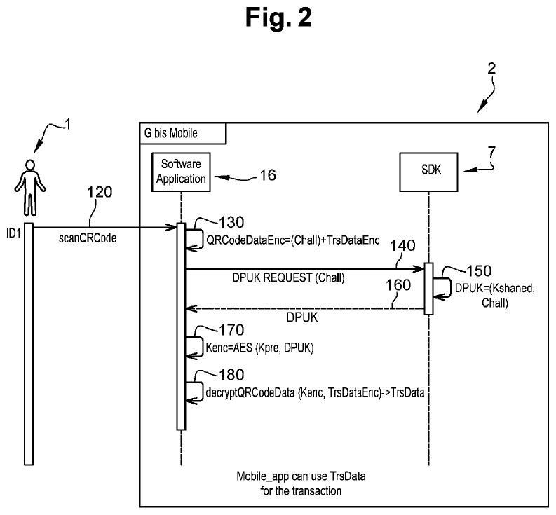

In FIG. 2, the second part of the method and system for securing an electronic transaction is described below.
In step 120, the user uses their smartphone (in the example) to scan or photograph the code displayed on their PC or tablet device with which they had connected to the bank's website to perform the transaction.

This can be done with a secure mobile device, such as the one offered by the applicant “Gemalto CAP”, or a smart mobile phone equipped with special “Gemalto Mobile Protector” software. It may also have another device such as a “Gemalto token” to decrypt the transaction data that could be displayed in alphanumeric form and entered by the user manually.

In the example, the user uses a device 6bis (mobile phone) with a mobile (or software) application 16 (Gemalto Mobile Protector);
In step 130, the above device processes the photograph or scan of the QR code displayed on the screen of its communication terminal (personal computer) connected to the bank to read it and extract the data (formatted in this form) comprising the transaction data and the challenge (TrsDataEnc+Chall);

The device 6bis (for example, the mobile phone) also includes a secure software development kit (SDK) such as “Gemalto Mobile Protector” configured to generate a dynamic DPUK element similar to that generated by the authentication server in response to a request from the mobile application 16. The device 6bis (telephone) also contains the Kshared key shared with the authentication server 5.

The secret unique key, Kshared, can be securely exchanged during user enrollment; It can be securely stored and protected in the mobile device, for example, by advanced encryption and obfuscation methods, and be accessible via a secure access management process and access rights management mechanism. The corresponding protection processes are certified. The key can be protected and stored in particular according to a WBC (White-Box Cryptography) encryption method, homomorphic encryption.

The key may have been stored in the device for the purpose of enabling authentication of the user as part of an authentication procedure using an authentication server 5.

Such a procedure may comprise the steps of generating an OTP in the device 6bis based on a challenge received from the server 5 and the stored key 6 Kshared; and then a step of transmitting the OTP calculated by the device 6bis to the server 5 for authentication purposes after verification by the server of this calculated OTP. Conversely, an OTP can be generated in the device and then sent to the authentication server with an identifier linked to the shared secret key. This OTP is compared to an OTP calculated in the server based on the same shared key found with the identifier in the authentication server. A challenge may be a piece of information related to a counter that runs identically in the device 6bis and in the authentication server without there having been a transmission of that challenge from one to the other.

Alternatively, the challenge in the examples of the invention need not be transmitted in the exchanges. The identifier ID1 makes it possible to find an identical internal challenge in the server 5 and in the phone 6bis for example by sharing the same algorithm or calculation or determination method to generate a challenge or variable.
In step 140, the mobile application 16 makes a DPUK request to the software development kit 7;
In step 150, the Kit 7 generates a dynamic key DPUK in a similar way to the one generated in step 50 above in the server 5 with the extracted challenge or identical to the one of the server used to calculate DPUK;
In step 160, the DPUK is transmitted to application 16 of device 6bis,
In step 170, the mobile application 16 calculates the dynamic encryption key (Kenc) in the same manner as in step 70 above;
In step 180, the mobile application 16 can finally decrypt the encrypted transaction data (TrsDataEnc) using the encryption/decryption key (Kenc) to obtain the plaintext transaction data TrsData.

The user can view and control the data of their TrsData transaction. If that data match the ones they sent earlier, then they can continue the transaction and finalize it.

Alternatively, the invention and in particular, the dynamic keys of an authentication server can be diverted to make a connection by any means of communication to a communication entity (server 3, 4, internet site of any service provider, intranet site of a company, etc.).

Thus, for example, a user opens a login page of any communication entity or access portal. They enter their user identifier ID1 and password on an application of their mobile terminal, the application requests a dynamic DPUK key from the SDK of the terminal 6bis based on an internal challenge that it attaches to its request. The terminal SDK calculates and returns to the terminal application a dynamic DPUK key based on the challenge.

The terminal application encrypts sensitive connection data (user name, password, etc.), (optionally puts them in the form of a 2D code) and transmits them to the site (or communication entity) to be logged into, preferably accompanied by the challenge (or without challenge if the server can compute such a challenge on its own side) and an identifier of the terminal and/or another identifier linked to the shared key (Kshared). Alternatively, this identifier is part of the challenge as a fixed part and a variable part completes the identifier to form the challenge (for example, fixed radical and variable challenge as a suffix).

Upon receiving the dynamically encrypted connection data and the (optional) challenge, the communication entity (internet/intranet site or other computer to be connected), makes a DPUK request based on the (optional) challenge and the ID1 identifier via the computing cloud (C) to the authentication server 5. The authentication server 5 has a database of keys each shared with a user terminal.

The server 5 finds the corresponding secret key with an identifier ID1 of the user terminal (or user identifier) and the received challenge (or challenge obtained internally in a synchronized way or according to a method shared with the terminal), then in turn generates a DPUK having the same value as the one generated by the mobile terminal. Using this DPUK, the website 3, 4 (or any communication entity) decrypts the initial message to retrieve the connection data that can now be used to authenticate the user and grant the connection requested by the user.

In all examples and figures, the transmission of a challenge or variable (Chall) is a preferred embodiment but may be optional. The important thing is that the terminal 6bis or computing entity 4 understands or uses the same variable or challenge to obtain the same dynamic key DPUK.

The DPUK can be a HOTP (Event-based One-Time Password) or TOTP (Time-based One-Time Password). In our preferred example, it is a HOTP.

The HOTP and TOTP type OTP calculations are known per se.

The dynamic key in the sense of the invention is dynamic because its value or its calculation may depend on a variable such as an elapsed time value (timestamp, clock value), a counter value (in particular with regular or non-regular incrementing, in particular event-based), a value of a challenge that may change or be randomly selected with each transaction. It may depend on a combination of several variables that may or may not comprise a challenge.

The dynamic key also depends on a fixed shared value such as a key (kshared, a secret value, an encryption key).

Each of them can determine on its own end, by shared convention or according to the same algorithm or a shared rule, the same challenge (or the same variable). This may be, for example, a list of pre-established challenges previously saved (10 to 1000) in the authentication server and in each terminal (or computing entity 4) and selected in an order agreed in advance. An occasional synchronization between the server and the entities or terminals may be necessary in case of a problem or error.

Thus, the challenge or variable does not need to be generated or transmitted in steps 30, 40, 90, 130.

The challenge may be provided by the software application or determined by the SDK application to be generated in step 150 (FIG. 2).

Similarly, the “Kshared” key is preferably shared, but not necessarily in all use cases as below.

Beyond the description of an application of the invention to the encryption of transaction data, the inventors thought of the potential of an authentication server as such. They thought that the authentication server (5) could be used (independently of any client-server system, in particular a banking system) as an on-demand service server for any system or terminal wishing to obtain a DPUK for encryption or decryption purposes in particular.

This server can be hosted for example in an organization or entity, which may be a trusted institution or linked to a national government.

The server would include secret keys each associated with an identifier of a person, computer entity, or terminal.

According to one feature, this authentication server is configured to generate and communicate, upon request 50) and remotely, a dynamic key (6, DPUK) from a secret key and a variable or challenge: the dynamic key serving as a dynamic encryption/decryption key or base key for obtaining a dynamic data encryption/decryption key (with or without a change in format key, for example).

According to one feature, the variable (or said challenge) may be known to the terminal or computing entity. Thus, the same DPUK can be found and the information or data transmitted in each terminal or computer entity can be found in plaintext.

In an even simpler mode of operation, terminals or entities may not necessarily have the counterpart (similar functions) of the server to calculate a DPUK using an SDK application.

The invention (hijacked authentication server) would work as follows: a terminal 6bis wanting to encrypt data to be transferred to a terminal titer (not shown but which may be identical or similar to the terminal 6bis), makes a DPUK request to the authentication server on the basis of an identifier ID1 of the user of the terminal or an identifier ID1 of the terminal.

The server 5 retrieves from its HSM database a secret key (not shared) but associated with the identifier ID1, then generates a DPUK (dynamic variable value) with a challenge or generates an OTP;

This DPUK or OTP is transmitted to the terminal 6bis to encrypt, or serve as the basis for calculating an encryption key for the information or data. This data or information is encrypted with the encryption key and transmitted to the terminal 6ter with an identifier ID1 of the terminal or user.

The terminal or entity 6ter receives the encrypted information and upon receipt requires an OTP or DPUK identical to that obtained by the terminal 6bis from the authentication server 5 on the basis of the identifier ID1. The server 5 transmits this DPUK or OTP to the terminal 6ter, which enables the terminal to calculate an encryption/decryption key on the basis of this OTP or DPUK, which will be used to decrypt the information received from the terminal 6bis.

If necessary, a challenge can be transmitted to the server by the terminal 6bis to be integrated in the DPUK or OTP calculation within the server 4.

If necessary, this challenge can be integrated by the terminal 6bis in the calculation of the encryption key; it can be communicated to the terminal 6ter at the same time as the ID1 identifier to enable the same encryption/decryption key used by the terminal 6bis to be recalculated.

Thus, we see the potential of the authentication server used in the sense of the invention, as a provider of a key service or OTP(s), on demand. This request may come from any entity or computer processing or communication terminal, for the purpose of encrypting or decrypting any data or information.

Thus, the server 5 of the invention may only be used to authenticate a terminal using an OTP and may furthermore be used to provide OTPs or DPUKs to be used to encrypt or decrypt data.

Alternatively, the server 5 may not be an authentication server already deployed in the field, which is given a second use completely distinct from that of an authentication via OTP. It can instead be a dynamic key server deployed at least for the purpose of encrypting or decrypting data or information (without necessarily being an authentication server).

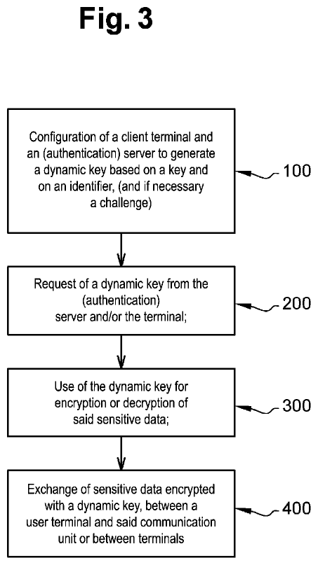

In FIG. 3, the invention provides another more generic implementation of the system of FIGS. 1 and 2 using at least part of the system possibly without SDK, without challenges, without QR code, without Kpre.
In step 100, the generic method provides for a configuration of a server 5 (dedicated or not to authentication) and/or a client terminal 6bis (with SDK for example) to generate a DPUK key or an OTP on the basis of a user or terminal identifier ID1 or of a computing entity 3 or 4. If necessary, the key can also be computed with a challenge or a variable that can be occasionally synchronized if necessary (or not) between entities (or terminals) and server 5;
In step 200, the method provides for a dynamic key (or OTP) request from a client terminal or client computing entity to the server 5 only or the server 5 and the terminal 6bis each on its own;
In step 300, the method may comprise a step of using the DPUK or OTP key directly as a dynamic encryption key (especially if the length of the OTP is sufficient) (or as a basis after transformation with another key or other parameter to obtain the dynamic encryption key), to encrypt or decrypt sensitive information or data;
In step 400, the method exchanges the encrypted sensitive data using a dynamic key, between a user terminal 6bis and a communication unit 3, 4 (or vice versa) or between the terminal 6bis and any terminal 6ter similar to 6bis.

Next, the terminal 6ter can request a DPUK key or an OTP from the server 5 based on the ID1 of the terminal 6bis, to decrypt the data received from the terminal 6bis directly or after calculating the encryption key based on the DPUK or the OTP.

Thus, the invention can envisage covering any computer or communication system that has access to the key server for encryption or decryption according to a general aspect of the invention and is able to request DPUK (or OTP) keys on demand. The server can be accessed via the cloud. Preferably, the invention provides for the reuse of authentication servers already deployed in the field for an authentication function of terminals or other computing devices or entities in order to implement the encryption or decryption function very quickly and at low cost.

For example, there is no need to enroll and re-provision each user's endpoint with keys shared between each endpoint and each user.

It is well understood that the invention has the advantage of being immediately applicable when reusing an existing infrastructure comprising an authentication server.

### TERMINOLOGY

TrsData=The data of the transaction being exchanged with the client mobile application, for example for a money transfer;
TrsDataEnc=encrypted transaction data;
Chall=random challenge (Challenge);
Kshared=Shared secret key stored in a secure memory area; Exchanged during an enrollment process (the key described in the context);
HOTP=HMAC based on an OTP (one-time password) algorithm;
TOTP=Time-based one-time password algorithm;
DPUK=Dynamic PUK, calculated as TOTP(KEY, DATA) or HOTP(KEY, DATA); To generalize we use DPUK(KEY,DATA);
Kpre (or Kpredefined)=Predefined key, a fixed random key obfuscated in the mobile application and known by the back-end of the bank:
Kenc=Dynamic encryption key

1. A system comprising a server comprising secret keys each associated with an identifier (ID1) of a user, computer entity or terminal, or terminal application,
characterized in that said server is configured to generate and communicate, on demand with the identifier (ID1), and remotely, a dynamic public key (6, DPUK) from a secret key (Kshared), and a variable or a challenge, said dynamic public key (6, DPUK) serving as a dynamic encryption/decryption key or as a basis for obtaining a dynamic data encryption/decryption key.

2. The system according to claim 1, characterized in that said variable or challenge is known to the terminal or computing entity.

3. The system according to claim 2, characterized in that said dynamic key comprises an one-time password (OTP), a HMAC based OTP (HOTP) or a Time-based OTP (TOPT).

4. The system according to claim 1, characterized in that said server is an authentication server.

5. A data communication system between at least one terminal and a computing entity said system comprising an authentication server according to claim 4, a service computing entity, and terminals,
said system being configured to:
authenticate each terminal or user with the authentication server based on a key shared (Kshared) between each terminal and said authentication server,
request the authentication server the terminal to generate a dynamic encryption key (DPUK) from said terminal shared key, and from a challenge or variable,
and use said dynamic key (DPUK) to encrypt, or decrypt said data exchanged between said terminal and said computing entity.

6. A communication system of claim 5, characterized in that each terminal is configured with a memory comprising a shared encryption/decryption key (Kshared) distinct from that of another terminal and shared with said authentication server.

7. A method for communicating data between at least one terminal and a computing entity, said method implementing a system comprising said authentication server according to claim 4, a service computing entity and terminals, said method comprising steps for:
configuring said system to authenticate each terminal or user with the authentication server based on a key shared (Kshared) between each terminal and said authentication server,
requesting the authentication server or the terminal to generate a dynamic encryption key (DPUK) from said shared key (Kshared) corresponding to the terminal, and from a challenge and/or variable,
using said dynamic key (DPUK) to encrypt or decrypt an exchange of data between said terminal and said computing entity.

8. The method according to claim 7, characterized in that said data exchange is distinct from an authentication data exchange comprising a one-time numerical password (OTP) exchanged between said terminal and said authentication server or said communication entity.

9. The method according to claim 8, characterized in that said dynamic encryption key (DPUK) is generated by said authentication server, in response to a specific standard or certified command issued by said communication computing entity.

10. The method of claim 9, characterized in that said dynamic encryption key comprises an OTP or HMAC based OTP (HOTP) or Time-based OTP (TOTP).

11. The method of claim 10, wherein said dynamic encryption key is dynamic because its value or its calculation depends on a variable such as an elapsed time value (either a timestamp or clock value), a counter value (in particular with regular or non-regular incrementing, in particular event-based), or a value of a challenge that may change or be randomly selected with each transaction.

12. The method of claim 10, wherein said dynamic encryption key depends on a fixed shared value such as a key that is one among a kshared, a secret value, and an encryption key.
